(19) United States
(12) Patent Application Publication
(10) Pub. No.: US 2006/0086057 A1
(43) Pub. Date: Apr. 27, 2006

(54) Protective storm windows

(76) Inventors: Kurt E. Rasenberger, Hubert, NC (US); Eric Rasenberger, (US)

Correspondence Address: LITMAN LAW OFFICES, LTD, PO BOX 15035, CRYSTAL CITY STATION, ARLINGTON, VA, 22215, US

(21) Appl. No.: 11/254,761

(22) Filed: Oct. 21, 2005

Related U.S. Application Data
(60) Provisional application No. 60/620,904, filed on Oct. 22, 2004.

(51) Int. Cl. E06B 3/26

(52) U.S. Cl. 52/202

(57) ABSTRACT

The protective storm window is a convex panel having a flat flange around the perimeter of the convex panel. The protective storm window is sized so that the flange may fit in to an existing frame of a window, door, vent or other opening in a building. The convex panel may be constructed out of fiberglass, plastic, metal or other suitable material depending on the intended use. Fixed and retractable pins are positioned along the outer edge of the flange to secure the protective storm window to an existing frame. One or more handles are attached to either the inside or outside of the flange to help a user install the protective storm window. The retractable pins may be spring-loaded and may be either individually operated or engage in unison through use of a sliding cam assembly. The protective storm window is stackable for easy storage.

### CROSS-REFERENCE TO RELATED APPLICATION

This application claims the benefit of U.S. Provisional Patent Application Ser. No. 60/620,904, filed Oct. 22, 2004.

### BACKGROUND OF THE INVENTION

1. Field of the Invention

The present invention relates to protective window coverings, and more particularly to a convex protective storm window that may be removably secured over a window, door or vent in order to protect against high winds and flying debris during a storm or unauthorized entry.

2. Description of the Related Art

The most vulnerable parts of a building are the openings, such as windows, doors and vents. During strong storms, especially gales or even hurricanes, high winds can cause flying debris that penetrates the openings in buildings, resulting often in severe damage within the building. Even in the absence of storms, building openings, particularly windows, are often the entry point for vandals or thieves.

Various ideas have been put forward in the field of protective window coverings for storms or for security. One of the simplest includes putting masking tape on windows in the event of a storm. The masking tape is supposed to prevent window glass from shattering in the event of a wind-borne object striking a window. This method has been found to be pretty much ineffective.

A more reliable approach to protecting a building from storm damage is to install storm shutters. The simplest form of storm shuttering is to nail pieces of plywood, preferably marine grade plywood, over any opening in a building. This method is effective but it leaves behind unsightly nail holes on the exterior of the building, and mounting the pieces of plywood can be time consuming and dangerous where upper level windows are concerned. Manufactured storm shutters also exist, but they are typically very costly, and most designs require mounting brackets or anchors secured to the frame of the window being covered.

The same points apply to many of the security coverings available, such as metal shields. Metal shields can be costly, difficult to install and can damage the aesthetics of a structure when in or out of use. Most storm or security covering are also opaque, which prevents an opening serving as a source of light in times of a power outage. Thus, a protective storm window solving the aforementioned problems is desired.

### SUMMARY OF THE INVENTION

The protective storm window is a convex panel having a flat flange around the perimeter of the convex panel. The protective storm window is sized so that the flange may fit in to an existing frame of a window, door, vent or other opening in a building. The convex panel may be constructed out of fiberglass, plastic, metal or other suitable material depending on the intended use. Fixed and retractable pins are positioned along the outer edge of the flange to secure the protective storm window to an existing frame. One or more handles are attached to either the inside or outside of the flange to help a user install the protective storm window. The retractable pins may be spring-loaded and may be either individually operated or may engage in unison through use of a sliding cam assembly. The sliding cam assembly may be operated using a lever or a gear. The protective storm window is stackable for easy storage.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of protective storm windows according to the present invention.

FIG. 2 is a side view of the protective storm window according to the present invention.

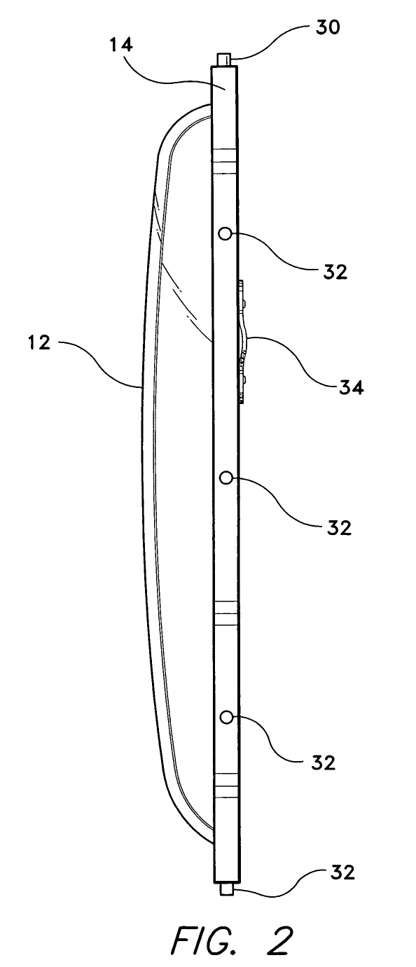

FIG. 3 is a back view of the protective storm window according to the present invention.

FIG. 4 is a close up front view of a sliding cam assembly for use with the protective storm window according to the present invention.

FIG. 5 is a close up front view of a sliding cam assembly utilizing a keyed swivel for use with the protective storm window according to the present invention.

FIG. 6 is a perspective view of a T-handled key according to the present invention.

FIG. 7 is a close up front view of a gear driven retractable pin according to the present invention.

FIG. 8A is a close up front view of a spring-loaded retractable pin according to the present invention in the engaged position.

FIG. 8B is a close up front view of spring-loaded retractable pin according to the present invention in the disengaged position.

FIG. 8C is a side view of the flange with slotted keyhole according to the present invention.

FIG. 9 is detailed back view of the flange with a collapsible handle attached according to the present invention.

FIG. 10 is detailed side view of the flange with a collapsible handle attached according to the present invention.

FIG. 11 is a perspective view of a stack of protective storm windows according to the present invention.

Similar reference characters denote corresponding features consistently throughout the attached drawings.

### DETAILED DESCRIPTION OF THE PREFERRED EMBODIMENTS

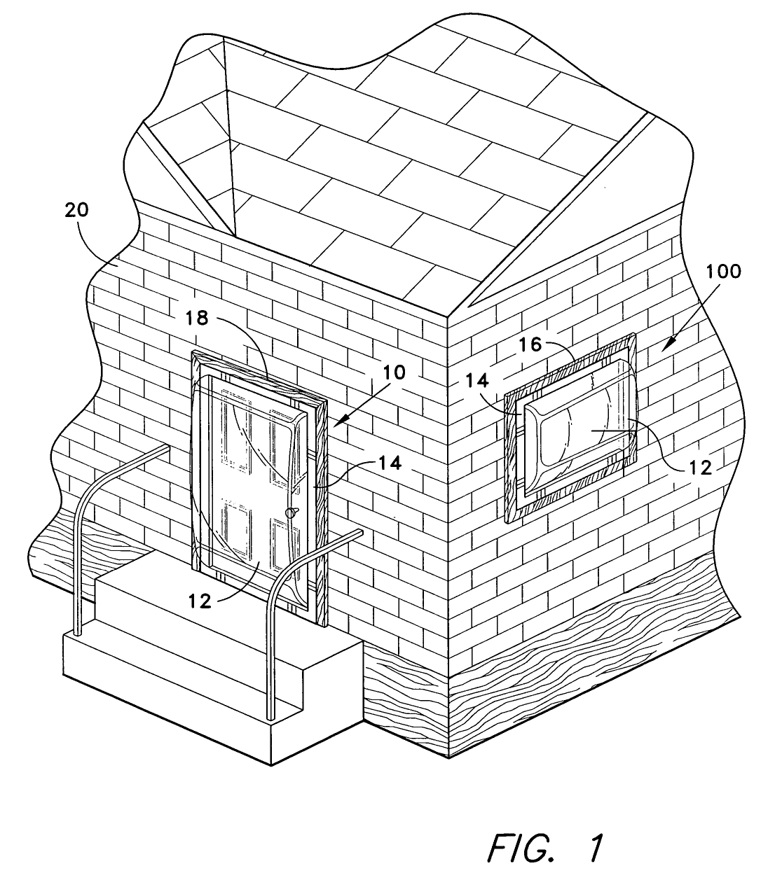

The present invention is a protective storm window, referred to generally as 10 when configured to cover a door and 100 when configured to cover a window in the drawings. The protective storm window comprises a convex panel 12 having a flat flange 14 around the perimeter of the convex panel 12. As shown in FIG. 1 the protective storm window 100 is sized so that the flange 14 may fit into a window frame 16, door frame 18, or other opening in a building 20. The domed shape of the convex panel 12 increases the strength of the protective storm window 100 in the event of high winds or the impact from flying debris. The convex panel may be constructed out of fiberglass, plastic, metal or other suitable material depending on the intended use. For security applications it may be more desirable to use metal or a high strength plastic, such as Kevlar® (Kevlar is a registered trademark of (E. I. du Pont de Nemours and Company). For protection from storms, a strong yet less expensive material, such as fiberglass, may be used with the present invention.

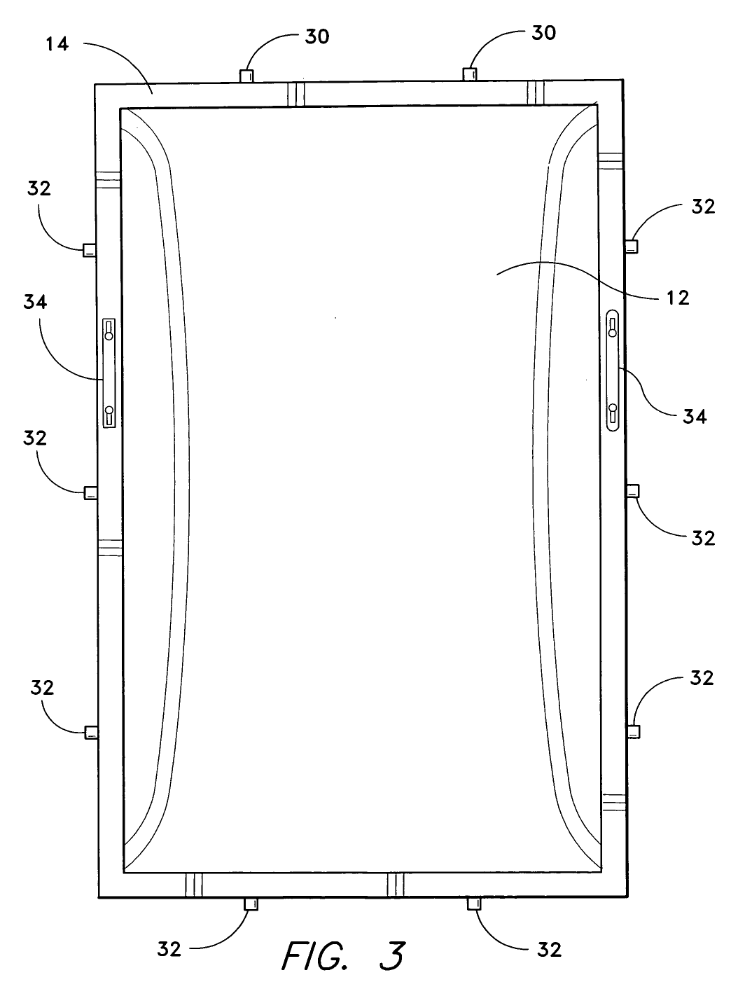

Fixed and retractable pins are positioned along the outer edge of the flange 14 to secure the protective storm window 100 to an existing frame. In one embodiment, featuring a rectangular protective storm window 100, as shown in FIG. 3, fixed pins 30 are positioned along the outward edge of the top of the flange 14. Retractable pins 32 are positioned along the outward edge of the remaining three sides of the flange 14. A collapsible handle 34 is attached on the front side of the flange 14.

To install the protective storm window 100 a user would first retract the retractable pins 32 from the outward edge of the flange 14. Next the user grips the collapsible handles 34 and moves the protective storm window 100 toward the window or door. Then, by positioning the storm window to engage the fixed pins 30 with a corresponding pin-receiving portion in the window or door perimeter, the protective storm window 100 is initially secured to the window or door. By tilting the protective storm window 100 at an angle to engage the remaining retractable pin 32, the user may then fully engage the storm window 100 to the window or door. The ability to be able to install the protective storm window from the upper stories of buildings from inside a building through the use of the collapsible handles 34 is a feature that increases the safety and efficiency of the present invention.

To uninstall the protective storm window 100, a user would first retract the retractable pins 32 from engaging slots in the window or door frame. Next the user grips the collapsible handles 34 and pushes the protective storm window 100 outward. Then by lowering the protective storm window downwards to disengage the fixed pins 30, the protective storm window is free. By tilting the protective storm window 100 at an angle, the user may then bring the protective storm window 100 inside the building. The ability to be able to uninstall the protective storm window 100 from the upper stories of a building through the use of the collapsible handles 34 is a feature that increases the safety and efficiency of the present invention.

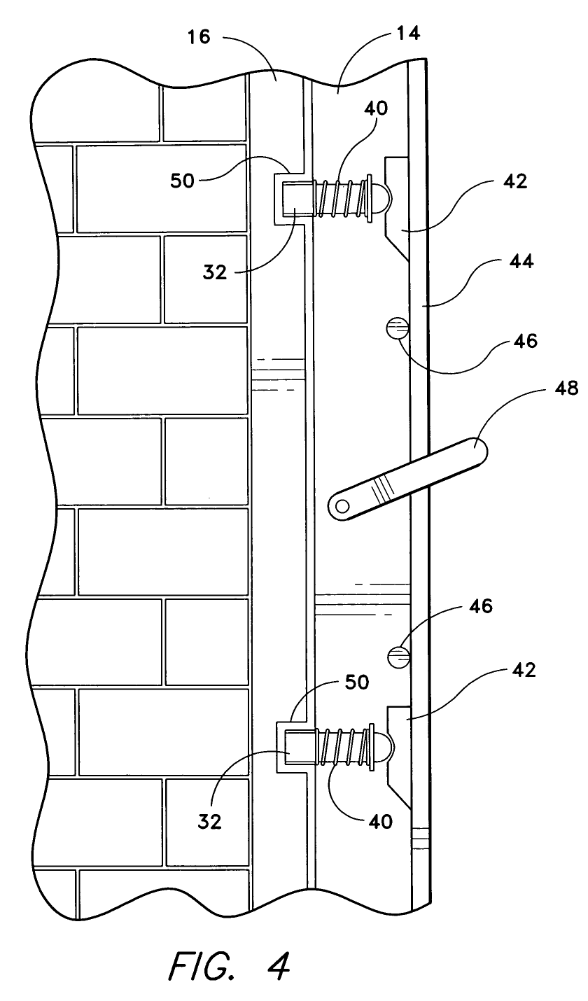

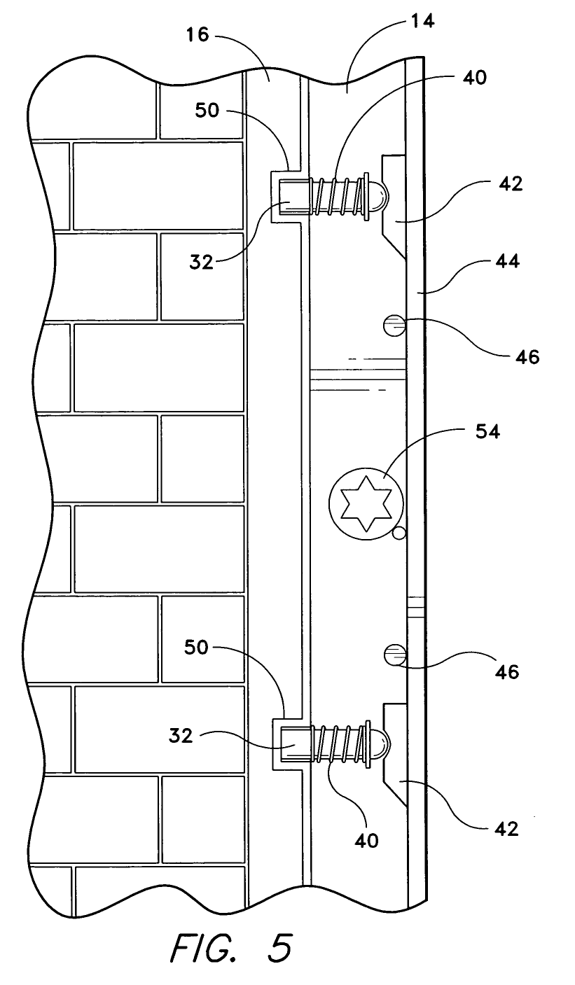

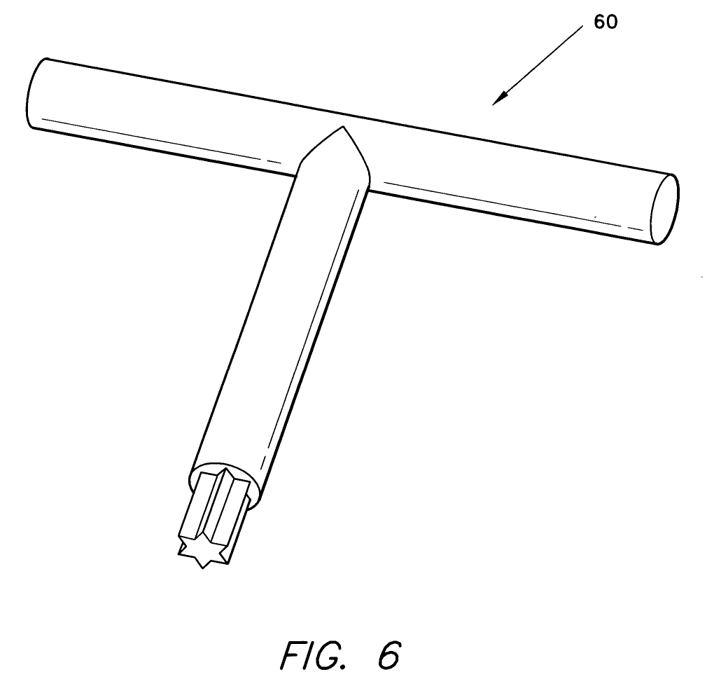

FIGS. 4-8 show some of the different ways that retractable pins 32 may be incorporated into the flange 14 of the protective storm window 100. FIG. 4 shows the retractable pins 32 mounted with springs 40. The retractable pins 32 are pushed outward by cams 42 mounted on a sliding track 44 that is held in place by rollers 46. Lever 48 extends through a slot in the track and controls sliding of the track so that a user would toggle the lever 48 in order to disengage the retractable pins 32 from slots 50 in the window frame 16. FIG. 5 shows a similar disengagement system utilizing cams 42, except a keyed swivel 54 controls the motion of the track 44. The keyed swivel 54 could pierce both sides of the flange 14 to allow a user to disengage the retractable pins 32 from either the inside or the outside of a building. It is contemplated that a T-handled key 60 such as is shown in FIG. 6 could be used to rotate the keyed swivel 54.

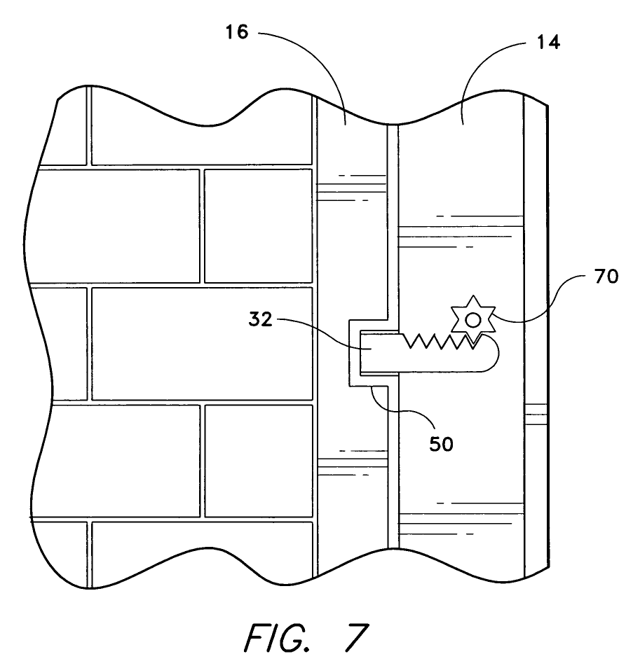

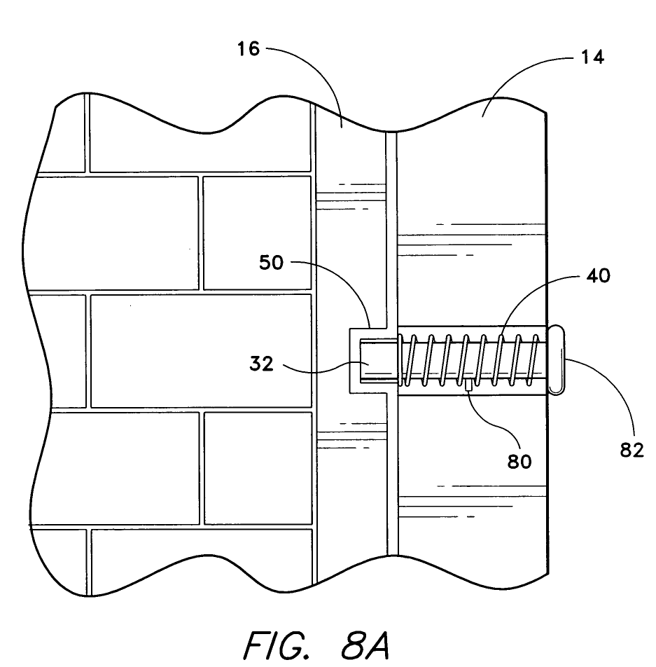

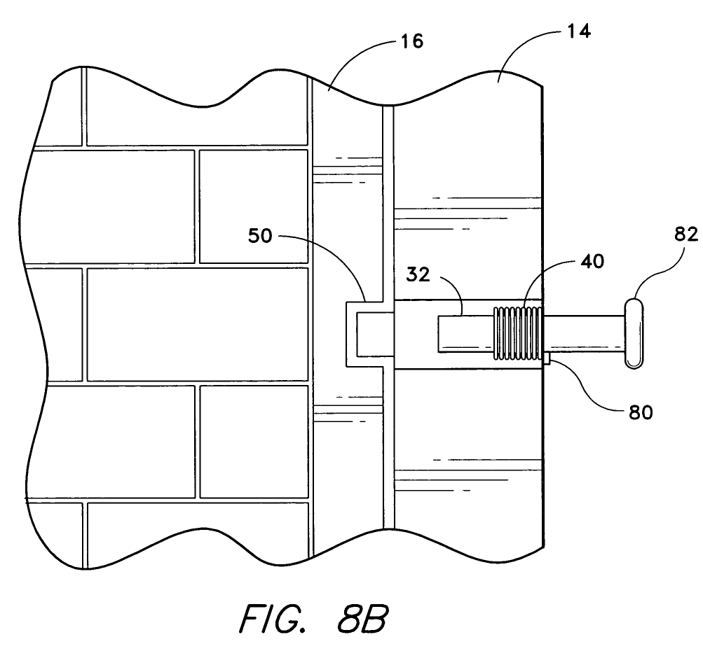

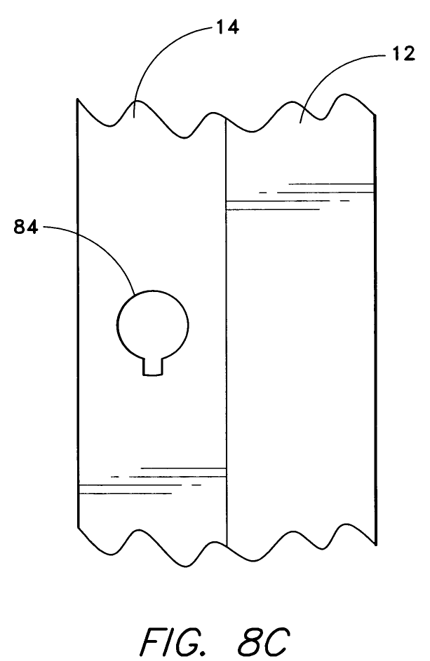

The sliding cam systems described above would allow for simultaneous engagement of the multiple retractable pins 32. It is contemplated that retractable pins 32 may be operated singly as well. FIGS. 7 and 8A-8C show two contemplated methods for individually operated retractable pins 32. In FIG. 7 each of the retractable pins 32 have teeth defining a rack that is engaged by a pinion gear 70 that, when turned, would engage or disengage the retractable pin 32 from slots 50 in the window frame 16. FIG. 8A shows a retractable pin 32 mounted with a spring 40 and further equipped with a stub 80 in the center of the retractable pin 32 and a knob 82 attached to the inward end of the retractable pin 32. FIG. 8B shows retractable pin 32 disengaged and held in the disengaged position by the stub 80. A slotted keyhole 84, as shown in FIG. 8C would allow for the passage of the stub 80.

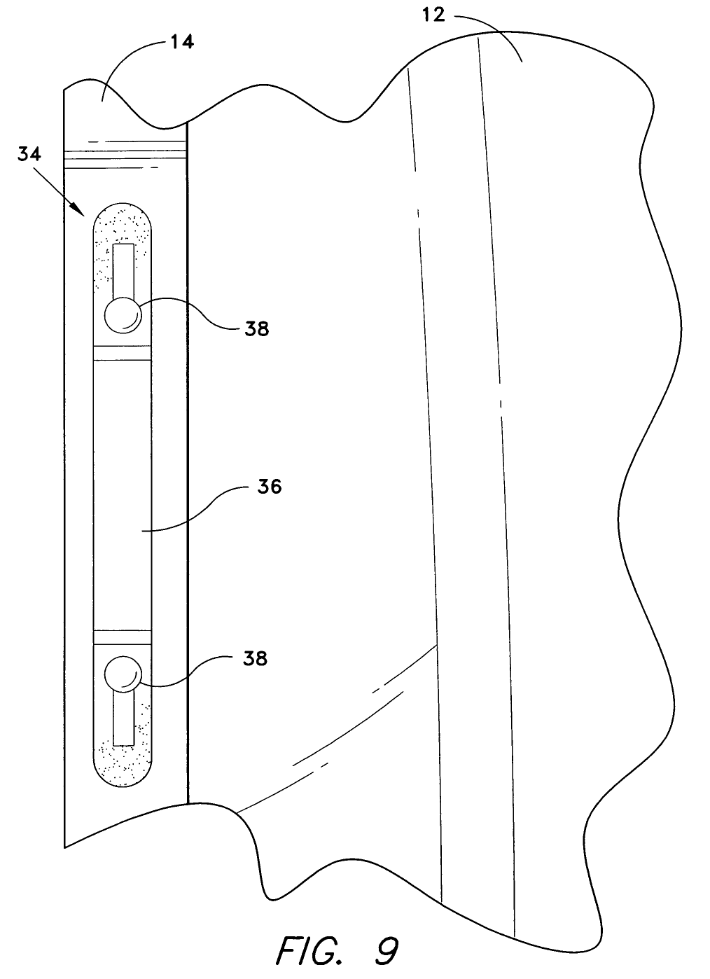

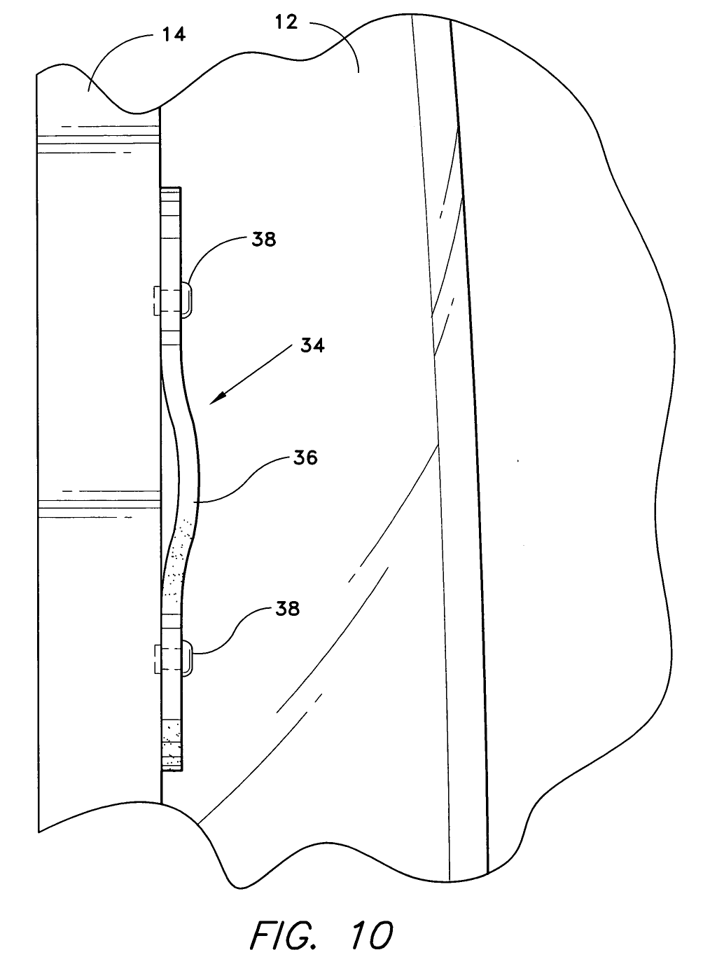

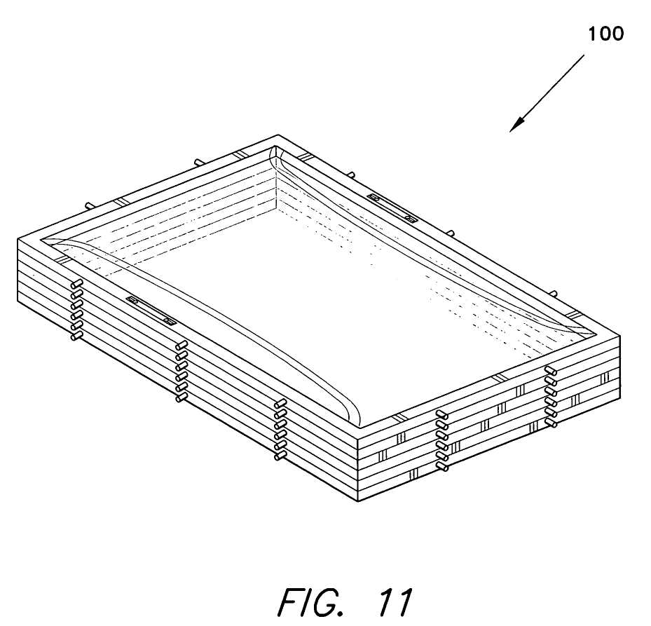

The collapsible handle 34 may be mounted on either the front or back of the flange 14. The collapsible handle 34 comprises a strap 36 with a lower and upper slot. As shown in FIGS. 9 and 10, the strap 36 is attached using two bolts 38 with heads larger than the slots so that the strap may either lie flat or bulge outward in order to admit the passage of a person's hand. By having the collapsible handle 34 in the flat position, the protective storm window 100 may be efficiently stacked for transportation or storage as shown in FIG. 11.

It is to be understood that the present invention is not limited to the embodiments described above, but encompasses any and all embodiments within the scope of the following claims.

We claim:

1. A protective storm window, comprising:
a convex panel;
a flange surrounding the perimeter of said convex panel, the flange having an outward edge at least one fixed pin positioned along a first portion of the outward edge of said flange; and,
at least one retractable pin positioned along a second portion of the outward edge of said flange.

2. The protective storm window according to claim 1, wherein said convex panel is constructed from high impact plastic.

3. The protective storm window according to claim 1, wherein said convex panel is constructed from a material selected from the group comprising metal, plastic and fiberglass.

4. The protective storm window according to claim 1, wherein said at least one fixed pin comprises a plurality of fixed pins positioned along the outward edge of said flange.

5. The protective storm window according to claim 4, wherein said flange is polygonal, having a plurality of sides, said plurality of fixed pins being positioned along only one of the sides of said flange.

6. The protective storm window according to claim 1, wherein said at least one retractable pin comprises a plurality of retractable pins positioned along the outward edge of said flange.

7. The protective storm window according to claim 6, wherein said flange is polygonal, having a plurality of sides, said plurality of retractable pins being positioned along at least two of the sides of said flange.

8. The protective storm window according to claim 1, further comprising:
at least one roller mounted on said flange;
at least one track slidably mounted to said flange, the track being retained by the roller;
at least one cam block mounted on the track, the cam block having a bearing face and a ramp sloping from the bearing face to the track; and
means for sliding the track between a first position in which said retractable pin is retracted and a second position in which the cam block bearing face bears against said retractable pin, extending the retractable pin in order to engage a bore defined in a window frame, said retractable pin sliding up the ramp onto the bearing face in moving from the first position to the second position.

9. The protective storm window according to claim 8, wherein said means for sliding the track comprises a rotating lock attached to said flange and a key insertable into the lock.

10. The protective storm window according to claim 8, wherein said means for sliding the track comprises a lever pivotally mounted to said flange, said track having a slot defined therein, said lever extending through the slot and bearing against said track in order to slide said track between the first and second positions.

11. The protective storm window according to claim 1, further comprising at least one handle mounted to said flange.

12. The protective storm window according to claim 11, wherein said handle is a collapsible strap handle.

13. The protective storm window according to claim 1, wherein said retractable pin has a plurality of teeth defined therein forming a rack gear, the protective storm window further comprising a pinion gear attached to said flange and engaging the rack gear in order to extend and retract said retractable pin.

14. The protective storm window according to claim 1, wherein said flange has a keyway defined therein, said retractable pin having a stud extending transverse to said pin and a head at one end of said pin, said pin and the stud defining a key slidable in the keyway with the head outside the keyway, said retractable pin further comprising a spring attached to an end of the pin opposite the head, the spring being confined within the keyway, the spring biasing said pin to an extended position in order to engage a bore defined in a window frame, said pin being retracted by pulling the head to remove the stud from the keyway and rotating said pin to lock said retractable pin in a retracted position.
